(19) United States
(12) Patent Application Publication
(10) Pub. No.: US 2026/0295527 A1
(43) Pub. Date: Oct. 1, 2026

(54) IMPROVED HYDROCARBON TRAP FOR COLD-START HYDROCARBON CONTROL FROM INTERNAL COMBUSTION ENGINES

(71) Applicant: BASF Mobile Emissions Catalysts LLC, Iselin, NJ (US)

(72) Inventors: Yuejin LI, Iselin, NJ (US); Andreas SUNDERMANN, Heidelberg (DE); Eduard KUNKES, Ludwigshafen am Rhein (DE)

(21) Appl. No.: 19/489,434

(22) PCT Filed: Jun. 7, 2024
(86) PCT No.: PCT/US2024/032899

§ 371 Date: Dec. 2, 2025

Related U.S. Application Data
(60) Provisional application No. 63/507,107, filed on Jun. 9, 2023.

(51) Int. Cl. B01D 53/94; F01N 3/10

(52) U.S. Cl. CPC B01D 53/945; F01N 3/101; F01N 3/106; B01D 2255/102; B01D 2255/104; B01D 2255/2022; B01D 2255/502; B01D 2255/9022; B01D 2255/9205; B01D 2257/702; F01N 2370/04

(57) ABSTRACT

A hydrocarbon trap catalyst for controlling hydrocarbon HC emissions from internal combustion engines. The catalyst comprises a molecular sieve comprising potassium and silver, wherein the molecular sieve has a minimum pore diameter of at least 4.5 A and a maximum pore diameter of less than 7.5 A and a silica to alumina ratio (SAR) in the range of 9.0 to 90.0, wherein the amount of potassium in the molecular sieve is in the range of 0.1% to 4.0% by weight, and the amount of silver in the molecular sieve is in the range of 0.2% to 10.0% by weight, in each case based on the total weight of the hydrocarbon trap catalyst. Also provided is a process for the preparation of the hydrocarbon trap catalyst. Also provided is hydrocarbon trap catalytic article and use thereof as a cold-start hydrocarbon trap.

### FIELD OF THE INVENTION

The presently claimed invention relates to a hydrocarbon trap catalyst.

Particularly, the presently claimed invention relates to the hydrocarbon trap catalyst for controlling hydrocarbon HC emissions from internal combustion engines.

More particularly, presently claimed invention relates to the hydrocarbon trap catalyst to control HC emissions from internal combustion engines at low exhaust temperature.

### BACKGROUND OF THE INVENTION

It is known that during an initial start or other period of engine operation while the engine is cold, referred to as a “cold operation period”, conversion of pollutants, especially hydrocarbons, is carried out with a low efficiency. Thus, a very substantial proportion of the total oxidizable pollutants, largely comprising hydrocarbons, discharged to the atmosphere during the cold operation period.

In order to ameliorate this problem, the art is aware of the expedient of using, in conjunction with the catalyst, a hydrocarbon trap material, such as certain zeolites, which will adsorb hydrocarbons at a low temperature at which the oxidation catalyst is relatively ineffective and desorb the hydrocarbons only at a more elevated temperature, at which conversion efficiency of the oxidation catalyst is higher than during the cold operation period.

One difficulty with known zeolite materials is that it tends to begin desorbing hydrocarbon, and thus releasing it to the catalyst, before the catalyst is hot enough to attain acceptably high conversion efficiencies.

Further, for most of HC trap materials, the HC release temperatures are too low to allow the released HC to be oxidized on a PGM containing catalyst. Thus, there exists a temperature gap between HC release temperature and catalyst effective (or light-off) temperature. Catalyst aging can further exacerbate the situation, which lowers HC release temperature but increases catalyst light-off temperature. The temperature gap is at least 100° C. for applications in gasoline powdered vehicles, where catalyst aging temperature can be 850° C. or higher. Overcoming this temperature gap is the biggest challenge in HC trap material research.

Accordingly, it is required to solve this problem by finding out a catalyst that can bridge the temperature gap after 850° C. hydrothermal aging, allowing to effectively control cold-start HC emissions in gasoline powered vehicles.

Thus, the object of the present invention is to provides a hydrocarbon (HC) trap composition to adsorb hydrocarbon (HC) at low temperatures and releasing the adsorbed hydrocarbon (HC) at high temperatures efficiently.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIGS. 1A and 1B illustrate the effect of metal cation in a beta zeolite on HC desorption profile for fresh samples and aged samples, respectively.

FIG. 1C illustrates comparative HC release temperature for fresh samples and aged samples. FIGS. 2A, 2B and 2C illustrate the effects of Ag, K and Ag/K in a beta zeolite on HC desorption profile on fresh catalysts, 750° C./5 hrs. aged catalysts and 850° C./5 hrs. aged catalysts, respectively.

FIGS. 2D, 2E and 2F illustrate the effects of Ag, K and Ag/K in a beta zeolite on HC release temperature on fresh catalysts, 750° C./5 hrs. aged catalysts and 850° C./5 hrs. aged catalysts, respectively.

FIGS. 2G, 2H and 2I illustrate the effects of Ag, K and Ag/K on the amounts of HC stored and released on fresh catalysts, 750° C./5 h aged catalysts and 850° C./5 hrs. aged catalysts, respectively. FIGS. 3A and 3B illustrate the effect of zeolite composition (SAR) on HC desorption profile for H-beta for fresh and aged samples, respectively.

FIG. 3C illustrates the effect of zeolite composition (SAR) on HC release temperature on H-beta. FIGS. 3D and 3E illustrate the effect of zeolite composition (SAR) on HC desorption profile for Ag/K modified beta for fresh and aged samples, respectively.

FIG. 3F illustrates the effect of zeolite composition (SAR) on HC desorption (peak) temperatures for Ag/K modified beta.

FIGS. 4A and 4B illustrate effect of binder in K/Ag/beta samples for fresh and aged samples, respectively.

FIGS. 4C and 4D illustrate HC desorption profiles on K/Ag, Mg/Ag, Ca/Ag and Zn/Ag modified beta for fresh and aged samples, respectively.

FIG. 4E illustrates the effect of binder on HC release peak temperatures for K/Ag/beta and the effect of divalent cations (Mg, Ca, Zn) in Ag/beta on HC release temperature.

FIG. 5A illustrates the effects of K and Ag loadings on the HC desorption profile of fresh samples.

FIG. 5B illustrates the effects of K and Ag loadings on the HC desorption profile of aged samples.

FIG. 5C illustrates the effects of K and Ag loadings on the HC release temperature of fresh and aged samples.

FIG. 6A illustrates HC desorption profiles on Li/Ag, Na/Ag and Cs/Ag modified beta for fresh samples.

FIG. 6B illustrates HC desorption profiles on Li/Ag, Na/Ag and Cs/Ag modified beta for aged samples.

FIG. 6C illustrates the effects of Li, Na, and Cs in Ag/beta on HC release temperature.

FIG. 7A is a perspective view of a honeycomb-type substrate carrier which may comprise the catalyst in accordance with one embodiment of the presently claimed invention.

FIG. 7B is a partial cross-section view enlarged relative to FIG. 7A and taken along a plane parallel to the end faces of the substrate carrier of FIG. 7A, which shows an enlarged view of a plurality of the gas flow passages shown in FIG. 7A.

FIG. 8 is a cutaway view of a section enlarged relative to FIG. 7A, wherein the honeycomb-type substrate in FIG. 7A represents a wall flow filter substrate monolith.

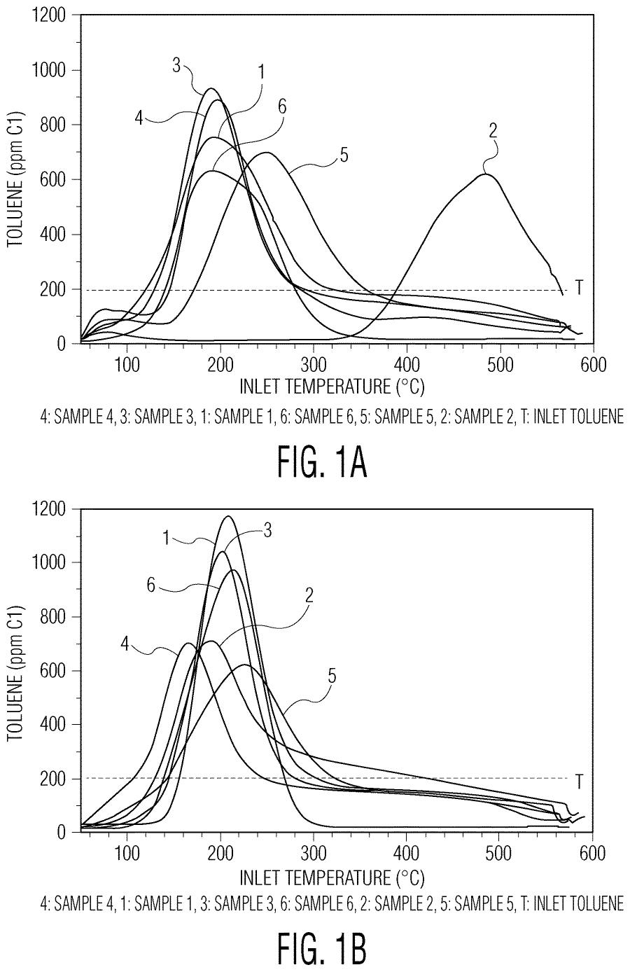

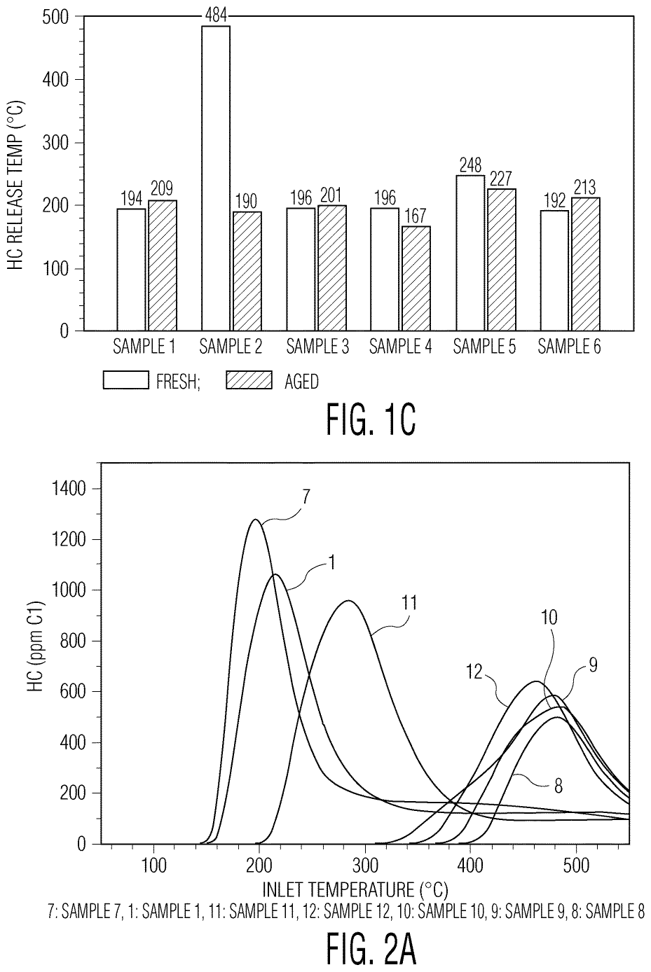

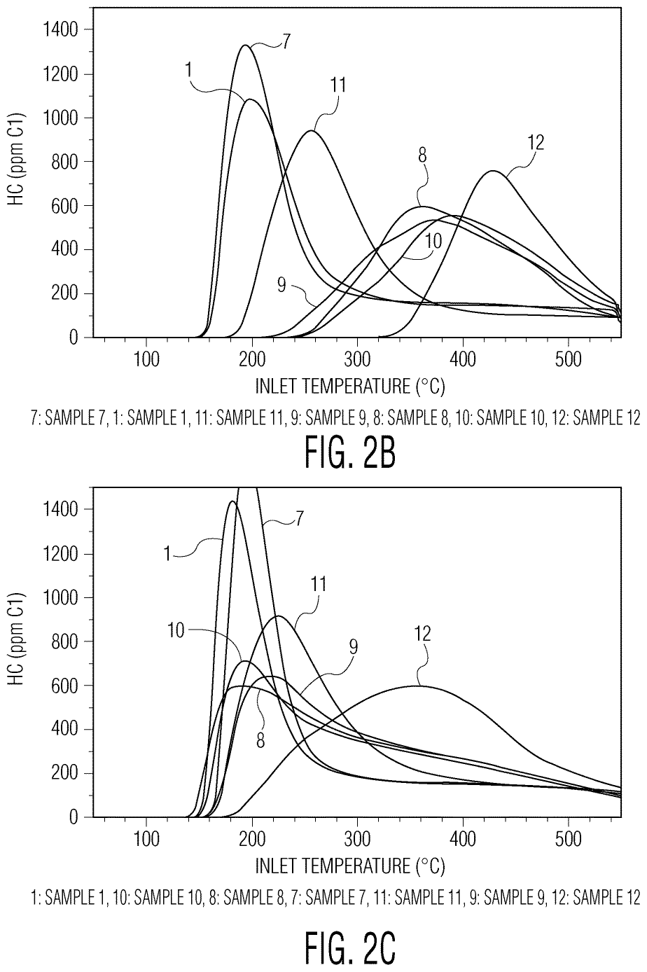

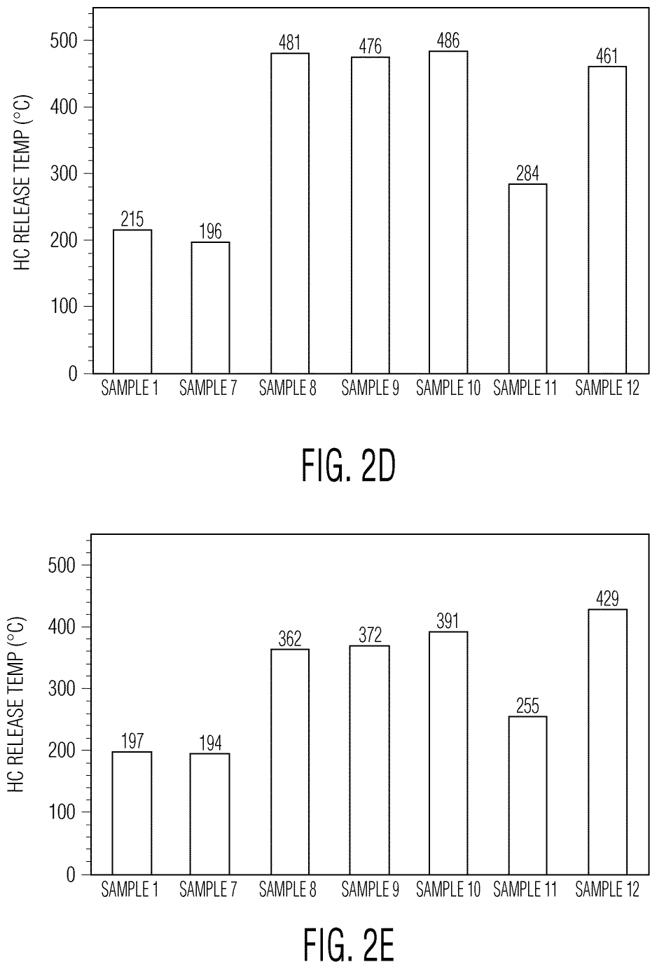

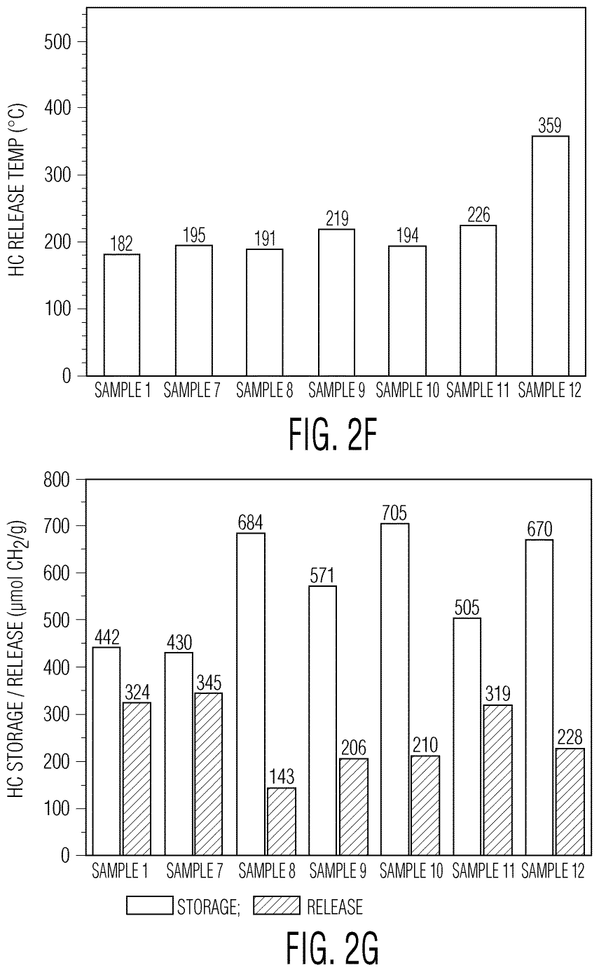

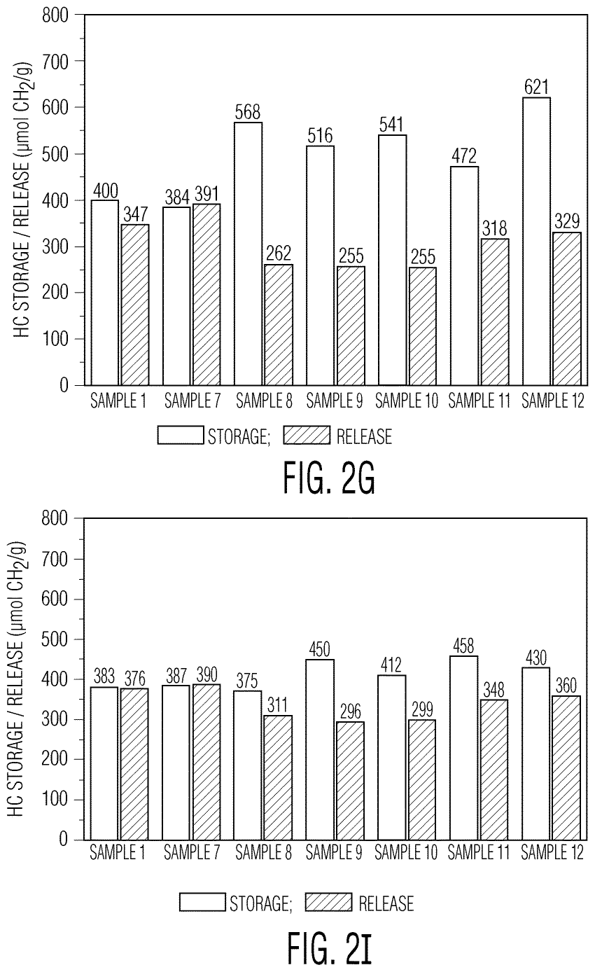

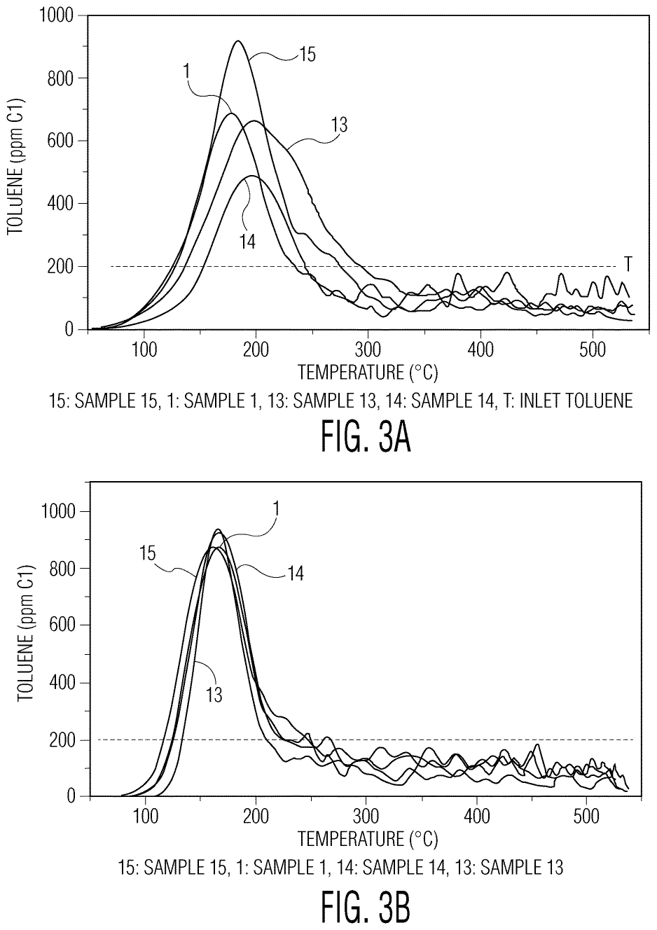

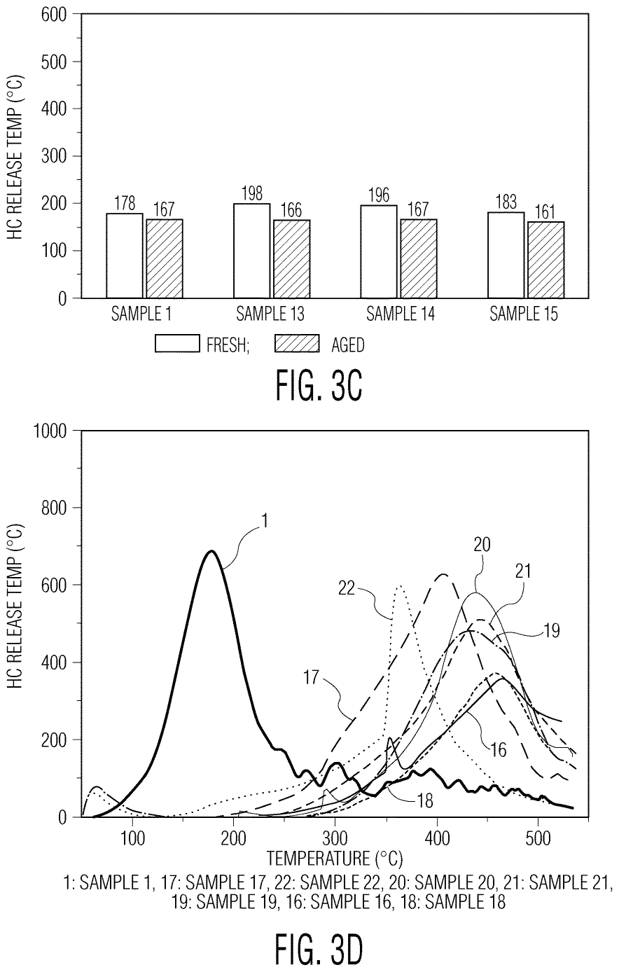

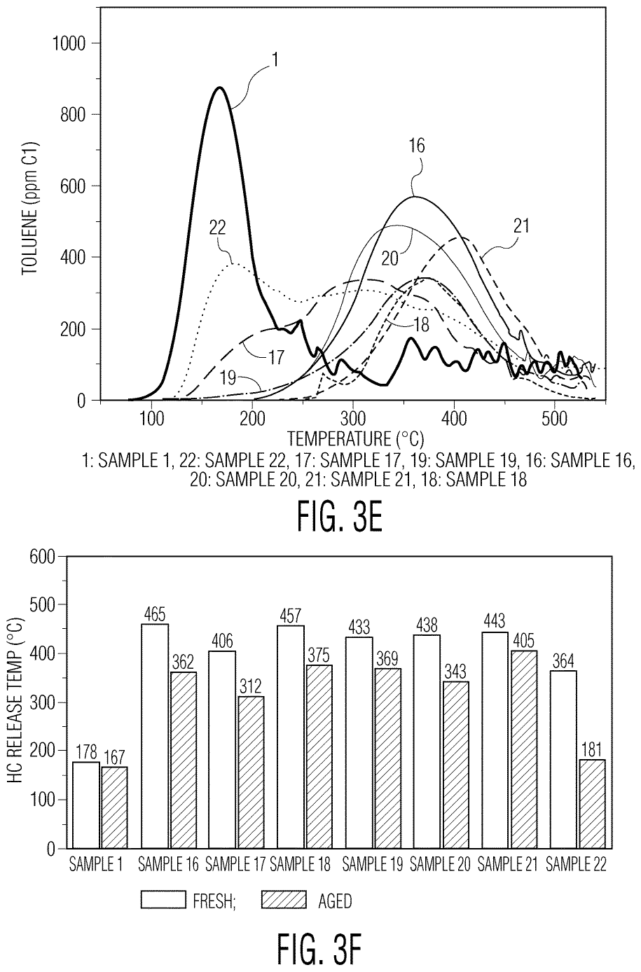

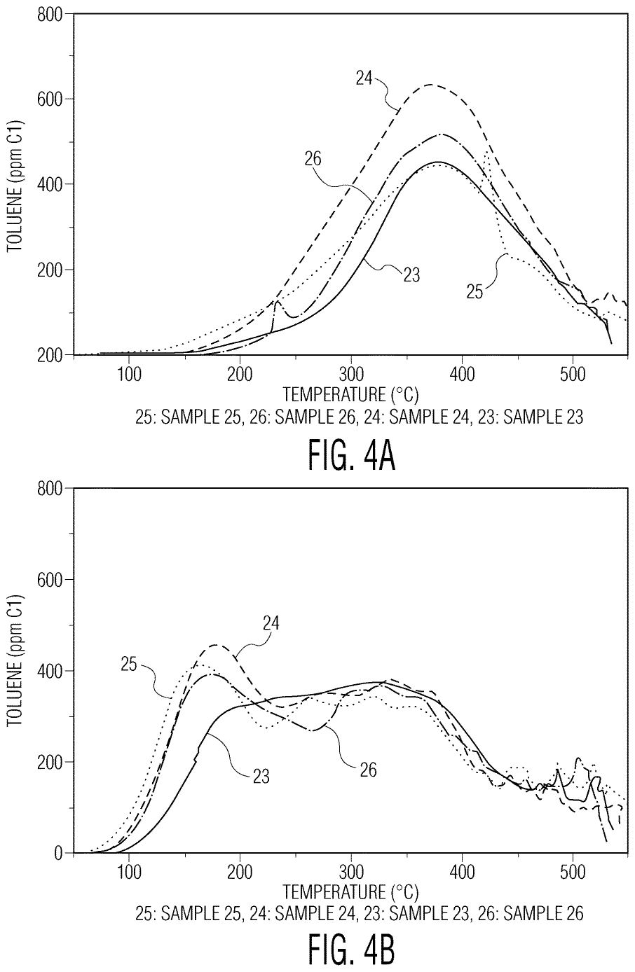

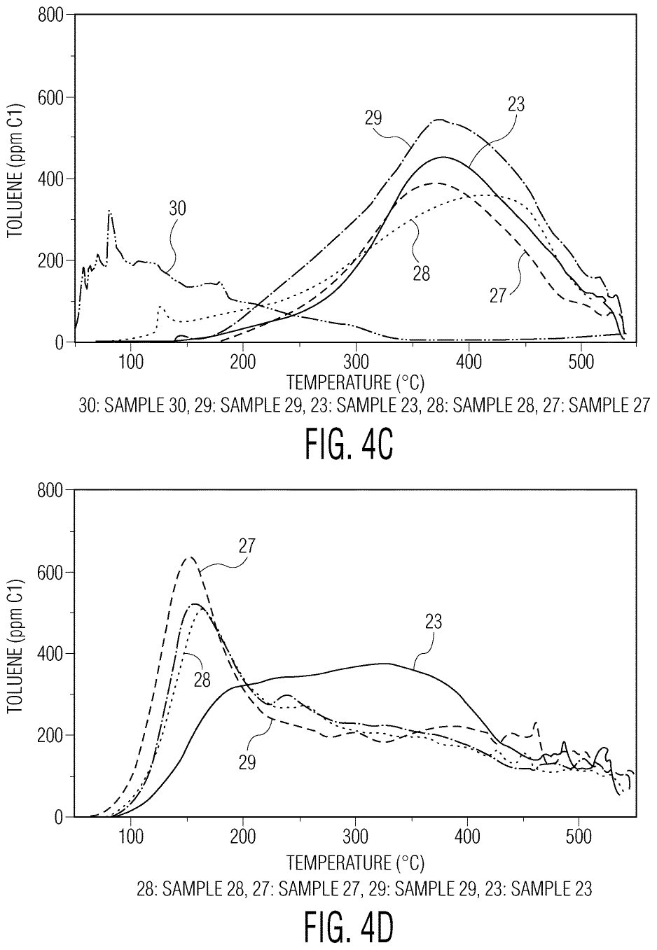

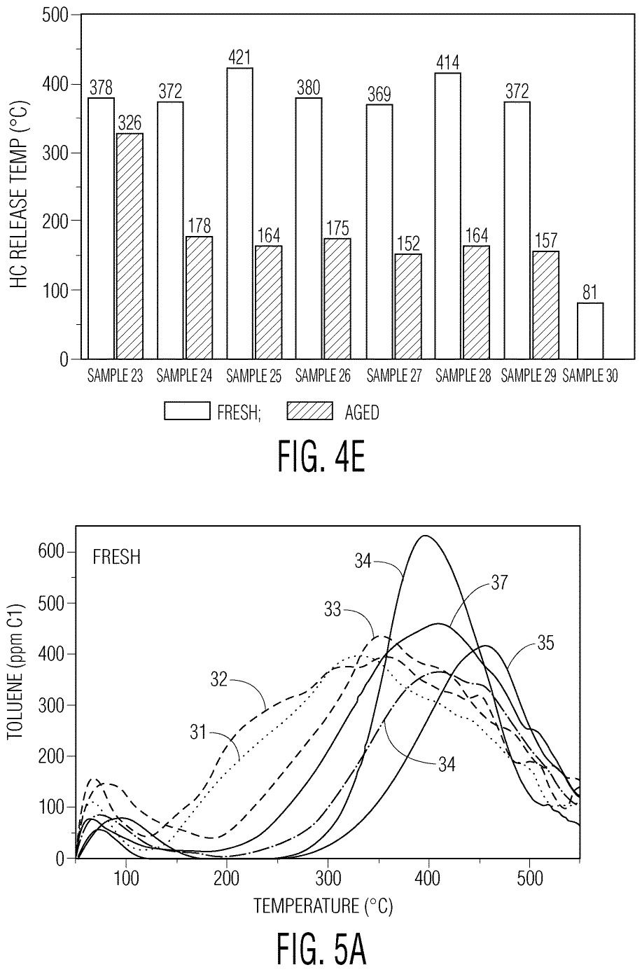

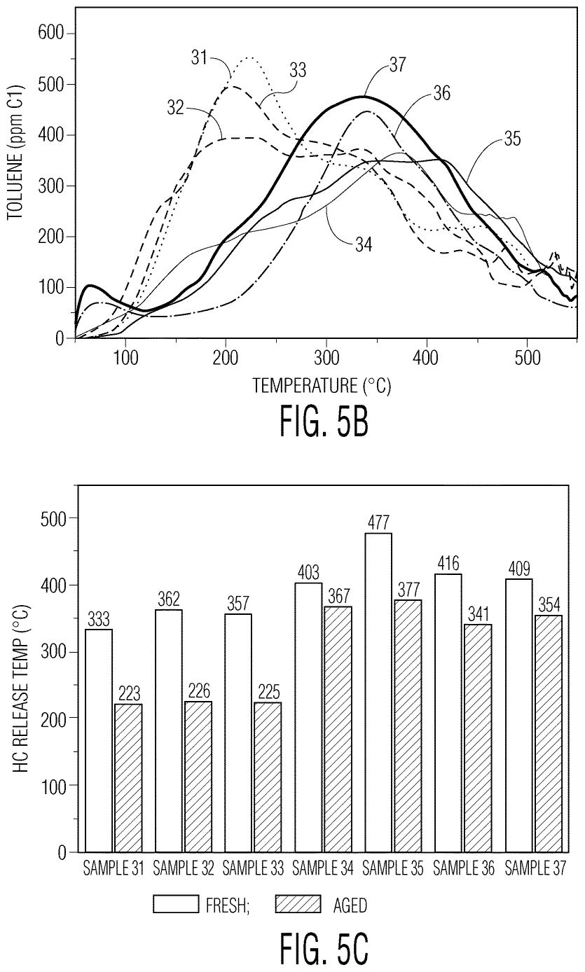

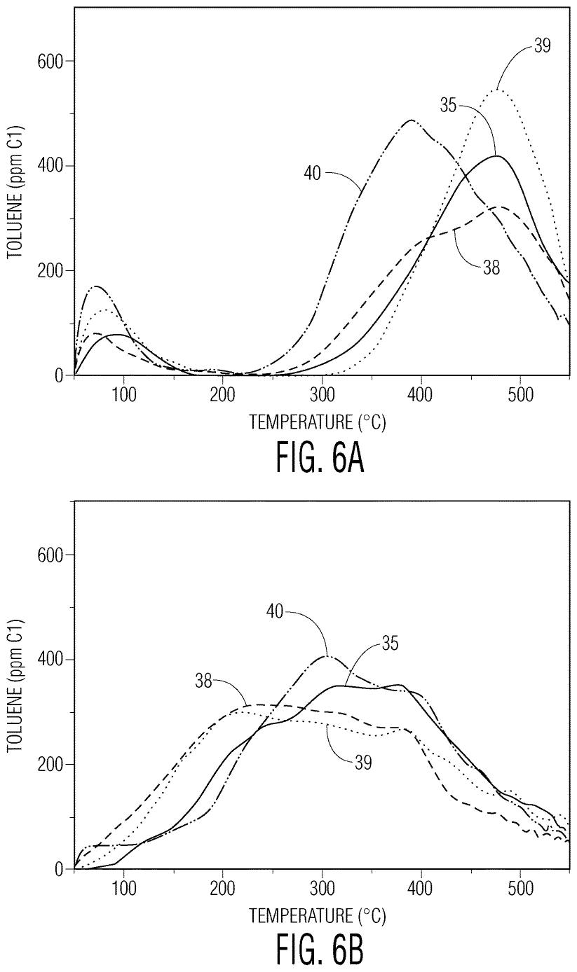

### DESCRIPTION OF THE INVENTION

The presently claimed invention will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### Definitions

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

### Hydrocarbon Trap

Hydrocarbon trap (HC trap) is referred to a storage material which adsorb hydrocarbon while the exhaust gas is cold and the three-way-catalyst is not yet active (for example during a cold start) and desorb and release them when the exhaust-gas temperature is higher and the three-way-catalyst has reached its light-off temperature. The examples of HC trap material include molecular sieves such as zeolites.

The term “three-way conversion catalyst” or TWC catalyst refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

In the context of the present invention the term “washcoat” is interchangeably used for “catalyst or catalyst composition deposited on a substrate in the form of a slurry” which forms one or more layers on a part of the respective substrate. As used herein, the term “washcoat” has its usual meaning in the art of a thin, adherent coating of a catalytic or other material applied to a substrate material. Generally, a washcoat is formed by preparing a slurry containing a certain solid content (e.g., 15-60% by weight) of particles in a liquid vehicle, which is then coated onto a substrate and dried to provide a washcoat layer on the respective substrate.

The term “NOx” refers to nitrogen oxide compounds, such as NO and/or NO2.

As used herein, the term “stream” broadly refers to any combination of flowing gas that may contain solid or liquid particulate matters.

As used herein, the terms “upstream” and “downstream” refer to relative directions according to the flow of an engine exhaust gas stream from an engine towards a tailpipe, with the engine in an upstream location and the tailpipe and any pollution abatement articles and catalysts being downstream from the engine.

The term “close-coupled” refers to a position of one or more catalytic converters which are placed in a proximity to the engine-out manifold.

The term “underfloor” refers to a position of one or more catalytic converters which are placed away from the close-coupled position. Usually, the underfloor catalytic converter is placed in the underfloor of the vehicle body between a close-coupled catalytic convert and a muffler.

As used herein, “impregnated” or “impregnation” refers to permeation of the catalytic material or metal/metal salt into the porous structure of the support material.

The term “co-impregnation” refers to a catalyst preparation method in which two soluble metal salts are mixed to obtain a mixture. The mixture is then impregnated on a support. According to the present invention, soluble platinum group metal salts and soluble promoter metal salts are mixed together to obtain a mixture. This mixture is then impregnated on a support.

### Hydrocarbon Trap Catalyst:

In one aspect, the present invention provides a hydrocarbon trap catalyst comprising a molecular sieve, the molecular sieve comprises a first metal and a second metal, wherein the first metal is potassium and the second metal is silver, wherein the molecular sieve has a minimum pore diameter of at least 4.5 Å and a maximum pore diameter of less than 7.5 Å and a silica to alumina ratio (SAR) in the range of 9.0 to 90.0, wherein the amount of potassium in the molecular sieve is in the range of 0.1% to 4.0% by weight, and the amount of silver in the molecular sieve is in the range of 0.2% to 10.0% by weight, in each case based on the total weight of the hydrocarbon trap catalyst.

### Molecular Sieve:

The term “molecular sieve” refers to porous solids with pores of the size of molecular dimension, 3-20 Å in diameter. Examples of molecular sieve include zeolites, carbons, glasses, oxides and phosphates. Some are crystalline with uniform pore size delineated by their crystal structure, e.g., zeolites. Others are amorphous, e.g., carbon molecular sieves. Most of current commercial molecular sieves are zeolites.

Preferably, the molecular sieve is zeolite. More preferably, the molecular sieve is beta-zeolite.

Zeolites are defined as aluminosilicates with open 3-dimensional framework structures composed of corner-sharing TO4 tetrahedra, where T is Al, or Si. Cations that balance the charge of the anionic framework are loosely associated with the framework oxygens, and the remaining pore volume is filled with water molecules. The non-framework cations are generally exchangeable, and the water molecules removable.

As used herein, the term “zeolite” refers to a specific type of molecular sieve with compositions comprising aluminosilicates of Group IA and Group IIA elements such as hydrogen, sodium, potassium, magnesium or calcium. Zeolites are crystalline materials having rather uniform pore sizes which, depending upon the type of zeolite and the type and amount of cations included in the zeolite lattice, range from about 3 to 10 Angstroms in diameter. The molar ratio of silica to alumina (SAR) of zeolites can vary over a wide range but is generally 2 or greater.

### Beta Zeolite:

Beta zeolite (with a structure code of BEA) has a complex structure consisting of an intergrowth of two distinct structures, polymorph A and polymorph B. Both polymorphs contain a three-dimensional network of 12-ring pores. Each polymorph grows as a two-dimensional sheet, and the sheets within beta zeolite randomly alternate between the two polymorphs. The intergrowth of the polymorphs has little effect on the pores in two of the dimensions, but in the faulting direction, the pores are tortuous rather than blocked.

Beta zeolite is widely used for pollutant abatement in various process industries and for automotive emission controls. Because of its large pore size, beta zeolite is ideal for adsorbing various sizes of hydrocarbon molecules.

Beta zeolite, typically in proton or H form, is known to be the best zeolite structure as a HC trap. However, the HC release temperature of a H-beta zeolite is too low, around 200° C., much lower than catalyst effective temperatures for HC oxidation. After aging, there is little difference in HC release temperature among beta zeolite materials regardless SiO2/Al2O3 ratio.

Exchanging transition metal cations (such as Cu, Ni, Co or Pd) in beta zeolite makes little difference in HC release temperature.

### BET Surface Area of Molecular Sieve:

“BET surface area” refers to the Brunauer, Emmett, Teller method for determining surface area by N2 adsorption.

Preferably, the BET surface area of the fresh molecular sieve 400 to 600 m²/g

Preferably, the BET surface area of the molecular sieve is 300 to 500 m²/g post aging at 850° C. for 5.0 hrs.

More preferably, the BET surface area of the molecular sieve 350 to 450 m²/g post aging at 850° C. for 5.0 hrs.

### Amount of Metals:

### Potassium

Preferably, the amount of potassium is in the range of 0.1 to 4.0% by weight, based on the total weight of the hydrocarbon trap catalyst. More preferably, the amount of potassium is in the range of 0.4 to 2.0% by weigh, based on the total weight of the hydrocarbon trap catalyst t. Even more preferably, the amount of potassium is in the range of 0.5 to 1.0% by weight, based on the total weight of the hydrocarbon trap catalyst.

### Silver

Preferably, the amount of silver is in the range of 0.2 to 10% by weight, based on the total weight of the hydrocarbon trap catalyst. More preferably, the amount of silver is in the range of 1.0 to 5.0% by weight, based on the total weight of the hydrocarbon trap catalyst. Even more preferably, the amount of silver is in the range of 2.0 to 4.0% by weight, based on the total weight of the hydrocarbon trap catalyst.

### Molar Ratio:

Preferably, the molar ratio of potassium and silver in the molecular sieve is in the range of 2:1 to 1:2. More preferably, the molar ratio of potassium and silver in the molecular sieve is in the range of 1.5:1 to 1:1.5. Preferably, the molar ratio of potassium to aluminum in the molecular sieve is in the range of 0.05 to 0.8. More preferably, the molar ratio of potassium to aluminum in the molecular sieve is in the range of 0.09 to 0.5.

Preferably, the molar ratio of silver to aluminum in the molecular sieve is in the range of 0.05 to 0.8. More preferably, the molar ratio of silver to aluminum in the molecular sieve is in the range of 0.09 to 0.5.

### Binder:

The term binder refers to a substance intended to improve the cohesion among solids components in a slurry and maintain the physical integrity of the washcoat after coating the slurry on a substrate. Although the primary role of a binder is physical in nature, it can have either desirable or undesirable interactions with the active component in the slurry, resulting altered performance in hydrocarbon adsorption and desorption.

Preferably, the catalyst comprises a binder selected from zirconia, alumina, silica, or any combination thereof. The binder can be in the form of an oxide, a hydroxide, a salt, or any combination thereof. More preferably, the binder is zirconia. Preferably, the source of zirconia is zirconium acetate.

Preferably, the amount of binder is in the range of 1.0 to 20.0% by weight, based on the total weight of the molecular sieve. More preferably, the amount of binder is in the range of 2.5 to 7.5% by weight, based on the total weight of the molecular sieve.

### Dopant:

The term “dopant” refers to a metal cation chemically attached to the exchangeable sites of a zeolite. A metal cation, depending on the nature of the metal, can have a greater interaction with hydrocarbon molecules relative to the proton. In addition, certain metal cations can better stabilize zeolite structures against hydrothermal aging compared to the proton. Mixed metal cations can have a synergistic effect in maintaining hydrothermal stability of a zeolite and increasing the adsorption strength for hydrocarbons.

Preferably, the molecular sieve comprises a dopant selected from lithium, sodium, cesium, calcium, magnesium, zinc, or any combination thereof. Preferably, the dopant is ion-exchanged and is present in an elemental form. Preferably, the amount of the dopant is in the range of 0.1 to 10% by weight, based on the total weight of the molecular sieve. More preferably, Preferably, the amount of the dopant is in the range of 0.1 to 5.0% by weight, based on the total weight of the molecular sieve. Even more preferably, the amount of the dopant is in the range of 0.2 to 2.0% by weight, based on the total weight of the molecular sieve.

In one embodiment, the molecular sieve comprises silver and potassium impregnated on the molecular sieve.

In another embodiment, the molecular sieve comprises liquid-phase ion exchanged silver and potassium on the molecular sieve.

In still another embodiment, the molecular sieve comprises solid-state ion exchanged silver and potassium on the molecular sieve.

In a preferred embodiment, the hydrocarbon trap catalyst comprising a molecular sieve, the molecular sieve comprises a first metal and a second metal, wherein the first metal is potassium and the second metal is silver, wherein the molecular sieve has a minimum pore diameter of at least 4.5 Å and a maximum pore diameter of less than 7.5 Å and a silica to alumina ratio (SAR) in the range of 20.0 to 64.0, wherein the amount of potassium in the molecular sieve is in the range of 0.4% to 2.0% by weight, and the amount of silver in the molecular sieve is in the range of 1.0% to 5.0% by weight, in each case based on the total weight of the hydrocarbon trap catalyst, wherein the molecular sieve is zeolite.

In one more preferred embodiment, the hydrocarbon trap catalyst comprising a molecular sieve, the molecular sieve comprises a first metal and a second metal, wherein the first metal is potassium and the second metal is silver, wherein the molecular sieve has a minimum pore diameter of at least 4.5 Å and a maximum pore diameter of less than 7.5 Å and a silica to alumina ratio (SAR) in the range of 20.0 to 64.0, wherein the amount of potassium in the molecular sieve is in the range of 0.4% to 2.0% by weight, and the amount of silver in the molecular sieve is in the range of 1.0% to 5.0% by weight, in each case based on the total weight of the hydrocarbon trap catalyst, wherein the molecular sieve is beta zeolite.

In one most preferred embodiment, the hydrocarbon trap catalyst comprising a molecular sieve and a binder, the molecular sieve comprises a first metal and a second metal, wherein the first metal is potassium and the second metal is silver, wherein the molecular sieve has a minimum pore diameter of at least 4.5 Å and a maximum pore diameter of less than 7.5 Å and a silica to alumina ratio (SAR) in the range of 20.0 to 64.0, wherein the amount of potassium in the molecular sieve is in the range of 0.4% to 2.0% by weight, and the amount of silver in the molecular sieve is in the range of 1.0% to 5.0% by weight, in each case based on the total weight of the hydrocarbon trap catalyst, wherein the molecular sieve is beta zeolite, wherein the binder is zirconia.

### Process for the Preparation of the Hydrocarbon Trap Catalyst:

The present invention also provides a process for the preparation of the hydrocarbon trap catalyst as defined herein above; the said process comprises at least the following steps:
Step a): A silver salt solution is impregnated on the molecular sieve to obtain a silver containing molecular sieve material.
Step b): The silver containing molecular sieve material obtained in step (a) is calcined at a temperature ranging from 300 to 500° C. for 1.0 to 2.0 hours in air to obtain a calcined silver containing molecular sieve material.
Step c): A potassium salt solution is impregnated on the calcined silver containing molecular sieve material to obtain a potassium-silver containing molecular sieve material.
Step d): The potassium-silver containing molecular sieve material is calcined at a temperature ranging from 500 to 650° C. for 1.0 to 2.0 hours to obtain the hydrocarbon trap catalyst.

Preferably, the molecular sieve is zeolite. More preferably, the molecular sieve is beta zeolite.

Preferably, the step (b) is carried out at a temperature ranging from 350 to 450° C. for 1.0 to 2.0 hours.

Preferably, the step (d) is carried out at a temperature ranging from 515 to 575° C. for 1.5 to 2.0 hours.

### Catalytic Article:

In another aspect, the present invention provides a hydrocarbon trap catalytic article comprising the hydrocarbon trap catalyst, as defined herein above, deposited on a first substrate, wherein the first substrate is honeycomb substrate or flow through substrate. Preferably, the hydrocarbon trap catalytic article is a single layered article or a two layered catalytic article or a zoned catalytic article.

Preferably, the washcoat loading of the hydrocarbon trap catalyst is 1.0 to 4.0 g/in³. More preferably, the washcoat loading of the hydrocarbon trap catalyst is 2.0 to 3.0 g/in³.

Preferably, the hydrocarbon trap catalytic article comprises a first layer deposited at least on a part of the first substrate and a second layer deposited at least on a part of the first layer, wherein the first layer comprises the hydrocarbon trap catalyst as defined herein above; and the second layer comprises a three-way conversion catalyst comprising at least one platinum group metal selected from platinum, palladium or rhodium supported on a support.

Preferably, the total platinum group metal (PGM) loading is 1.0 to 200 g/ft³. More preferably, the total platinum group metal (PGM) loading is 5.0 to 100 g/ft³.

### Support/Support Material:

A “support” in a catalytic material or catalyst composition or catalyst washcoat refers to a material such as alumina, ceria-alumina composite, ceria-zirconia mixed oxide etc. that receives metals (e.g., PGMs), stabilizers, promoters, binders, and the like through precipitation, association, dispersion, impregnation, or other suitable methods.

The term “supported” throughout this application has the general meaning as in the field of heterogenous catalysis. In general, the term “supported” refers to an affixed catalytically active species or its respective precursor to a support material. The support material may be inert or participate in the catalytic reaction. Commonly supported catalysts are prepared by impregnation methods or co-precipitation methods and optional subsequent calcination.

Preferably, the support is selected from ceria-alumina composite, ceria-zirconia mixed oxide, alumina, and rare earth metal-oxide doped ceria-zirconia solid solution.

### Ceria-Alumina Composite:

Ceria-alumina composite is a composite in which CeO2 is distributed on the surface of alumina and/or in the bulk as particles and/or nano clusters. Each oxide may have its distinct chemical and solid physical state. The surface CeO2 modification of alumina can be in the form of discrete moieties (particles or clusters) or in the form of a layer of ceria that covers the surface of alumina partially or completely.

Preferably, the amount of the ceria-alumina composite present in the catalytic article is in the range of 5.0 to 80 wt. %, based on the total weight of the second layer. More preferably, the amount of the ceria-alumina composite present in the catalytic article is in the range of 10 to 60 wt. %, based on the total weight of the second layer. More preferably, the amount of the ceria-alumina composite present in the catalytic article is in the range of 15 to 40 wt. %, based on the total weight of the second layer.

The amount of CeO2 (cerium oxide) in the ceria-alumina composite present in the second layer is preferably 1.0 to 60 wt. %, based on the total weight of the ceria-alumina composite in the second layer. More preferably, the CeO2 in the ceria-alumina composite present in the second layer is 5.0 to 50 wt. %, based on the total weight of the ceria-alumina composite in the second layer. Even more preferably, the CeO2 in the ceria-alumina composite present in the second layer is 5.0 to 30 wt. %, based on the total weight of the ceria-alumina composite in the second layer. And even more preferably, the CeO2 in the ceria-alumina composite present in the second layer is 8.0 to 20 wt. %, based on the total weight of the ceria-alumina composite in the second layer.

The amount of Al2O3 (aluminium oxide) in the ceria-alumina composite present in the second layer is preferably 40 to 99 wt. % based on the total weight of the ceria-alumina composite in the second layer. More preferably, the Al2O3 in the ceria-alumina composite present in the second layer is 50 to 95 wt. % based on the total weight of the ceria-alumina composite in the second layer. Even more preferably, the Al2O3 in the ceria-alumina composite present in the second layer is 70 to 95 wt. % based on the total weight of the ceria-alumina composite in the second layer. And even more preferably, the Al2O3 in the ceria-alumina composite present in the second layer is 80 to 92 wt. %, based on the total weight of the ceria-alumina composite in the second layer.

Preferably, the average particle size of ceria in the ceria-alumina composite is less than 200 nm. More preferably, the particles size is in the range of 5.0 nm to 50 nm. The particle size is determined by transition electron microscopy.

The ceria-alumina composite present in the second layer may comprise a dopant selected from zirconia, lanthana, titania, hafnia, magnesia, calcia, strontian, baria or any combination thereof. The total amount of dopant in the ceria-alumina composite is preferably in the range of 0.001 to 15 wt. % based on the total weight of the ceria-alumina composite in the second layer.

The ceria-alumina composite can be made by methods known to the person skilled in the art like co-precipitation or surface modification. In these methods, a suitable cerium containing precursor is brought into contact with a suitable aluminium containing precursor and the so obtained mixture is then transformed into the ceria-alumina composite. Suitable cerium containing precursors are for example water soluble cerium salts and colloidal ceria suspension. Ceria-alumina can also be prepared by the atomic layer deposition method, where a ceria compound selectively reacts with an alumina surface, which after calcination forms ceria on the alumina surface. This deposition/calcination step can be repeated until a layer of desired thickness is reached. Suitable aluminium containing precursors are for example aluminium oxides like gibbsite, boehmite gamma alumina, delta alumina or theta alumina or their combinations. Transformation of the so obtained mixture into the ceria-alumina composite can then be achieved by a calcinations step of the mixture.

### Ceria-Zirconia Mixed Oxide (CZO):

The term of complex metal oxide refers to a mixed metal oxide that contains oxygen anions and at least two different metal cations. In the ceria-zirconia mixed oxide, cerium cations, zirconium cations are distributed within the oxide lattice structure. The terms “complex oxide” and “mixed oxide” can be used interchangeably. As the metal cations are distributed within the oxide lattice structure, these structures are also commonly referred to as solid solutions.

Preferably, the amount of the ceria-zirconia mixed oxide present in the second layer is 20 to 80 wt. %, based on the total weight of the second layer. More preferably, the amount of ceria-zirconia mixed oxide present in the second layer is in the range of 30 to 70 wt. %, based on the total weight of the second layer. Most preferably, the amount of ceria-zirconia mixed oxide present in the second layer is in the range of 40 to 60 wt. %, based on the total weight of the second layer. Preferably, ceria (calculated as CeO2) of the ceria-zirconia mixed oxide present in the second layer is present in an amount of 10 to 60 wt. %, based on the total weight of the ceria-zirconia mixed oxide present in the second layer and zirconia (calculated as ZrO2) of the ceria-zirconia mixed oxide present in the second layer is present in an amount of 40 to 90 wt. %, based on the total weight of the ceria-zirconia mixed oxide present in the second layer.

More preferably, ceria (calculated as CeO2) of the ceria-zirconia mixed oxide present in the second layer is present in an amount of 20 to 50 wt. %, based on the total weight of the ceria-zirconia mixed oxide in the second layer and zirconia (calculated as ZrO2) of the ceria-zirconia mixed oxide present in the second layer is present in an amount of 50 to 80 wt. %, based on the total weight of the ceria-zirconia mixed oxide in the second layer.

Even more preferably, ceria (calculated as CeO2) of the ceria-zirconia mixed oxide present in the second layer is present in an amount of 30 to 50 wt. %, based on the total weight of the ceria-zirconia mixed oxide in the second layer and zirconia (calculated as ZrO2) of the ceria-zirconia mixed oxide present in the second layer is present in an amount of 50 to 70 wt. %, based on the total weight of the ceria-zirconia mixed oxide in the second layer.

The ceria-zirconia mixed oxide serves as oxygen storage component. The term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions.

In a preferred embodiment, the ceria-zirconia mixed oxide present in the second layer comprises a dopant selected from lanthana, titania, hafnia, magnesia, calcia, strontia, baria, yttrium, hafnium, praseodymium, neodymium, or any combinations thereof. The dopant metal may be incorporated in a cationic form into the crystal structure of the complex metal oxide, may be deposited in an oxidic form on the surface of the complex metal oxide, or may be present in the oxidic form as a blend of mixtures of both dopants and complex metal oxide on a micro-scale, so to say in a composite form with the complex metal oxide. Preferably, the dopant(s) are comprised in an amount of 1.0 to 20 wt. %, or more preferably in an amount of 5.0 to 15 wt. %, based on the total weight of the ceria-zirconia mixed oxide present in the second layer.

### Alumina:

Alumina present in the second layer is preferably gamma alumina or activated alumina. It typically exhibits a BET surface area of fresh material in excess of 60 square meters per gram (“m2/g”), often up to about 200 m²/g or higher. Activated alumina is usually a mixture of the gamma and delta phases of alumina, but may also contain substantial amounts of eta, kappa and theta alumina phases. Preferably, the activated alumina is high bulk density gamma-alumina, low or medium bulk density large pore gamma-alumina, low bulk density large pore boehmite or gamma-alumina.

Preferably, the amount of alumina present in the second layer is in the range of 1.0 to 40 wt. %, based on the total weight of the second layer. More preferably, the amount of the alumina present in the second layer is in the range of 5.0 to 30 wt. %, based on the total weight of the second layer. Most preferably, the amount of alumina present in the second layer is in the range of 5.0 to 20 wt. %, based on the total weight of the second layer.

Alumina present in the catalytic article is preferably doped with a dopant selected from barium, lanthana, zirconia, neodymian, yttria, ceria or titania, wherein the amount of the dopant is preferably 1.0 to 30 wt. % based on the total weight of alumina and dopant present in the second layer. More preferably, alumina doped with dopant/s is selected from lanthana-alumina, titania-alumina, ceria-zirconia-alumina, zirconia-alumina, lanthana-zirconia-alumina, baria-alumina, baria-lanthana-alumina, baria-lanthana-neodymia-alumina, or any combination thereof.

### Rare Earth Metal-Oxide Doped Zirconia Solid Solution:

Rare earth metal-oxide doped zirconia solid solution is defined as a crystalline zirconia material that incorporates one or more rare earth metals into its bulk structure, forming a single crystallographic phase as measured by X-ray diffraction spectrometer.

The substitution of a minor fraction of the cations in the host oxide lattice with external metal ions is referred as doping. i.e. in doping, the dopant element/s replace the metal element in the parent structure without changing the type of crystal phase. However, the lattice parameter (crystallinity or surface area) may change due to the size difference between dopant element and the metal element of the parent structure. For example, when La is incorporated in a monoclinic ZrO2 structure the composite has the same structure as monoclinic ZrO2. However, due to smaller the smaller ionic radius of La (vs. Zr) its lattice parameters (unit cell volume) are slightly smaller. The degree of shrinkage (or shift of XRD 2Theta position) depends on the content of the La dopant.

The term “solid solution” refers to a homogenous mixture of two different kinds of atoms in solid state and have a single crystal structure.

Preferably, the rare earth metal is selected from lanthanum, praseodymium, neodymium, yttrium, or any combination thereof. More preferably, the rare earth metal is lanthanum.

Most preferably, the support is a lanthanum oxide doped zirconia solid solution.

Preferably, the amount of rare earth metal, in an oxide form, in the rare earth metal-oxide doped zirconia solid solution is in the range of 1.0 to 25 wt. %, based on the total weight of the rare earth metal-oxide doped zirconia solid solution and the amount of zirconia in the rare earth metal-oxide doped zirconia solid solution is in the range of 75 to 99 wt. %, based on the total weight of the rare earth metal-oxide doped zirconia solid solution.

Preferably, the hydrocarbon trap catalytic article comprises a first zone and a second zone, wherein the first zone comprises the hydrocarbon trap catalyst as defined herein above deposited at least on an inlet part of the first substrate and the second zone comprising a three-way conversion catalyst comprising at least one platinum group metal selected from platinum, palladium or rhodium supported on a support, deposited at least on an outlet part of the first substrate.

In the context of the present invention the term “first zone” is interchangeably used for “inlet zone” or “front zone” and the term “second zone” is interchangeably used for “outlet zone” or “rear zone” The terms “first zone” and “second zone” also describe the relative positioning of the catalytic article in flow direction, respectively the relative positing of the catalytic article when placed in an exhaust gas treatment system. The first zone would be positioned upstream, whereas the second zone would be positioned downstream. The first zone covers at least some portion of the substrate from the inlet of the substrate, whereas the second zone covers at least some portion of the substrate from the outlet of the substrate. The inlet of the substrate is a first end which is capable to receive the flow of an engine exhaust gas stream from an engine (flow-in end portion), whereas the outlet of the substrate is a second end from which a treated exhaust gas stream exit (flow-out end portion).

The substrate is coated with catalytic layers, namely a first layer and a second layer in a zoned fashion. A first zone is coated with the first catalytic layer (i.e. hydrocarbon trap catalyst) and a second zone is coated with the second catalytic layer (i.e. three-way conversion catalyst). The first catalytic layer covers 60 to 100% area of the first zone and the second catalytic layer covers 60 to 100% area of the second zone.

The first zone occupies a flow-in end portion of the substrate and the second zone occupies a flow-out end portion of the substrate.

The first zone and the second zone together cover 50 to 100% of length of the substrate. Preferably, the first and second zone together cover 90 to 100% of the length of the substrate and more preferably, the first and the second zone together cover the whole length or the whole accessible surface area of the substrate.

The term “accessible surface” refers to the surface of the substrate which can be covered with the conventional coating techniques used in the field of catalyst preparation like impregnation techniques.

Preferably, the first zone covers 10 to 90% of the entire substrate length from an inlet and the second zone covers 90 to 10% of the entire substrate length from an outlet, while the first zone and the second zone together cover 20 to 100% of the length of the substrate. More preferably, the first zone covers 20 to 80% of the entire substrate length from the inlet and the second zone covers 80 to 20% of the entire substrate length from the outlet, while the first zone and the second zone together cover 40 to 100% of the length of the substrate. Even more preferably, the first zone covers 30 to 70% of the entire substrate length from the inlet and the second zone covers 70 to 30% of the entire substrate length from the outlet, while the first zone and the second zone together cover 60 to 100% of the length of the substrate. Even most preferably, the first zone covers 40 to 50% of the entire substrate length from the inlet and the second zone covers 50 to 40% of the entire substrate length from the outlet, while the first zone and the second zone together cover 80 to 100% of the length of the substrate.

### First Zone:

The first zone is coated with the first catalytic layer which comprises hydrocarbon trap catalyst.

Preferably, the first catalytic layer covers 60 to 100% area of the first zone. More preferably, the first catalytic layer covers 70 to 100% area of the first zone. Most preferably, the first catalytic layer covers 80 to 100% area of the first zone.

### Second Zone:

The second zone is coated with the second catalytic layer which comprises a three-way conversion catalyst comprising at least one platinum group metal selected from platinum, palladium or rhodium supported on a support. Preferably, the second catalytic layer covers 60 to 100% area of the second zone. More preferably, the second catalytic layer covers 70 to 100% area of the second zone. Most preferably, the second catalytic layer covers 80 to 100% area of the second zone.

### Substrate:

The substrate (first substrate or second substrate) of the catalytic article of the presently claimed invention may be constructed of any material typically used for preparing automotive catalysts. In a preferred embodiment, the substrate is a ceramic substrate, metal substrate, ceramic foam substrate, polymer foam substrate or a woven fiber substrate. In a more preferred embodiment, the substrate is a ceramic or a metal monolithic honeycomb structure.

The substrate provides a plurality of wall surfaces upon which the catalytic layer/s or washcoat described herein above are applied and adhered, thereby acting as a carrier for the catalytic material.

Preferable metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g., 1025 wt. % of chromium, 3-8% of aluminium, and up to 20 wt. % of nickel. The alloys may also contain small or trace amounts of one or more metals such as manganese, copper, vanadium, titanium, and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Preferable ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates, and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminium-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

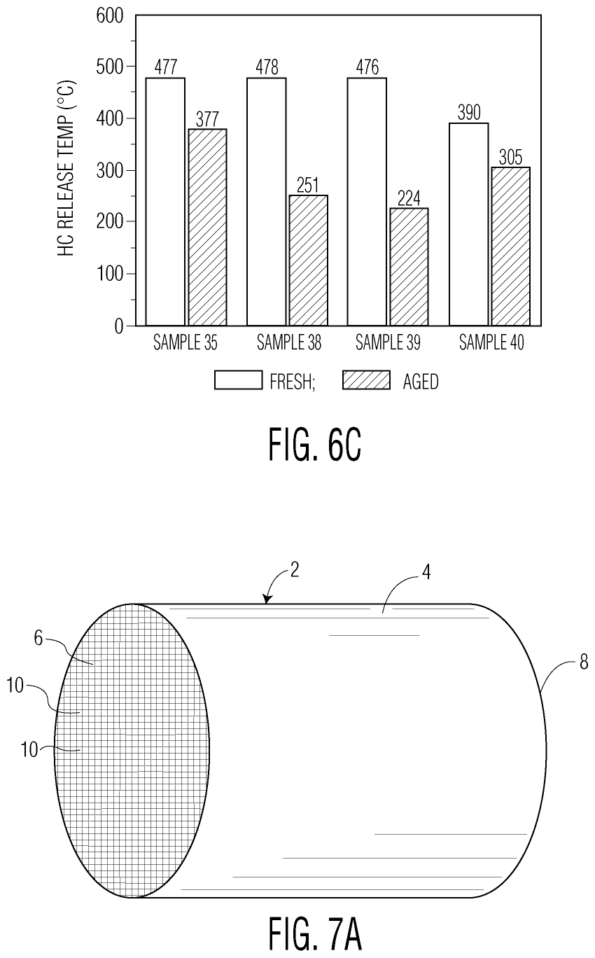

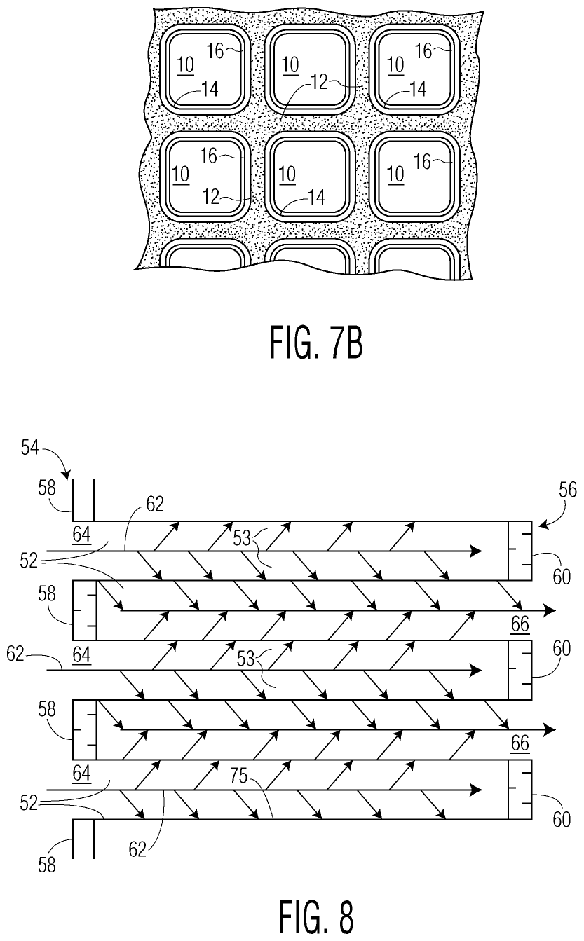

FIGS. 7A and 7B illustrate an exemplary substrate 2 in the form of a flow-through substrate coated with washcoat compositions/catalytic layer/s as described herein. Referring to FIG. 7A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 7B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 7B, walls 12 are so dimensioned and configured that gas flow passages 10 have a substantially regular polygonal shape. As shown, the washcoat compositions/catalytic layers can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

FIG. 8 illustrates an exemplary substrate 2 in the form of a wall flow filter substrate coated with a washcoat composition as described herein. As seen in FIG. 8, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element. Calcining.

### Preparation of Catalytic Article:

In another aspect of the present invention, there is also provided a process for the preparation of the catalytic article as described herein above.

Preferably, the process comprises:
preparing a first slurry containing the hydrocarbon trap catalyst as defined herein above;
depositing said first slurry on a first substrate, wherein the first substrate is honeycomb substrate or flow through substrate; and
subjecting the first substrate to calcination at a temperature ranging from 400 to 700° C. Preferably, the process comprises:
preparing a first slurry containing the hydrocarbon trap catalyst as defined herein above;
preparing a second slurry containing a three-way conversion catalyst comprising at least one platinum group metal selected from platinum, palladium or rhodium supported on a support
depositing the first slurry at least on part of the first substrate to obtain a first layer;
depositing the second slurry at least on part of the first layer to obtain a second layer; and
subjecting the substrate to calcination at a temperature ranging from 400 to 700° C.

Preferably, the process comprises:
preparing a first slurry containing the hydrocarbon trap catalyst as defined herein above;
preparing a second slurry containing a three-way conversion catalyst comprising at least one platinum group metal selected from platinum, palladium or rhodium supported on a support;
depositing the first slurry on the flow-in end portion of the substrate to obtain a first zone;
depositing the second slurry on the flow-out end portion of the substrate to obtain a second zone; and
subjecting the substrate to calcination at a temperature ranging from 400 to 700° C.

The step of preparing the slurry comprises a technique selected from incipient wetness impregnation, incipient wetness co-impregnation, and post-addition.

Incipient wetness impregnation techniques, also called capillary impregnation or dry impregnation are commonly used for the synthesis of heterogeneous materials, i.e., catalysts.

Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Rh (NO)3 and salts thereof), rhodium acetate, or combinations thereof where rhodium is the active metal; palladium nitrate, palladium tetra amine nitrate, palladium acetate, or combinations thereof where palladium is the active metal; and platinum nitrate, platinum acetate, or combination thereof where platinum is the active metal. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

### Substrate Coating:

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12. The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D90 particle size of about 10 to about 40 microns, preferably 10 to about 30 microns, more preferably about 10 to about 15 microns. The D90 is determined using a dedicated particle size analyzer. The equipment employed in this example uses laser diffraction to measure particle sizes in small volume slurry. The D90, typically with units of microns, means 90% of the particles by number have a diameter less than that value.

The slurry is coated on the catalyst substrate using any washcoat technique known in the art. E.g., the catalyst substrate is dipped one or more times in the slurry or otherwise coated with the slurry. Thereafter, the coated substrate is dried at an elevated temperature (e.g., 100-150° C.) for a period of time (e.g., 10 min-3.0 hours) and then calcined by heating, e.g., at 400-700° C., typically for about 10 minutes to about 3 hours. Following drying and calcining, the final washcoat coating layer is viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

The coated substrate can be aged, by subjecting the coated substrate to heat treatment. E.g., aging is done at a temperature of about 850° C. to about 1050° C. in the presence of steam under gasoline engine exhaust conditions for 50-300 hours. Aged catalyst articles are thus provided according to present invention. The effective support material such as ceria-alumina composites maintains a high percentage (e.g., about 50-100%) of their pore volumes upon aging (e.g., at about 850° C. to about 1050° C. in the presence of steam for about 50-300 hours aging).

### Emission Treatment System:

In another aspect of the present invention, there is also provided an exhaust gas treatment system comprising:
a) the hydrocarbon trap catalytic article as defined herein above; and
b) optionally, a three-way conversion catalytic article.

Preferably, the exhaust gas treatment system comprises:
i) an engine producing an exhaust gas stream;
ii) the hydrocarbon trap catalytic article as defined herein above; and
iii)) a three-way conversion catalytic article,
wherein the hydrocarbon trap catalytic article is positioned downstream from the engine and the three-way conversion catalytic article is positioned downstream in fluid communication with the hydrocarbon trap catalytic article.

Preferably, the three-way conversion catalytic article comprises at least one platinum group metal selected from platinum, palladium or rhodium supported on a second substrate. Preferably, the three-way conversion catalytic article is a single layered catalytic article or two layered catalytic article or a zoned catalytic article. Preferably, the total platinum group metal (PGM) loading is 1.0 to 200 g/ft³. More preferably, the total platinum group metal (PGM) loading is 5.0 to 100 g/ft³.

In another aspect of the present invention, there is also provided a method of treating a gaseous exhaust stream comprising hydrocarbons, carbon monoxide, and nitrogen oxide, the method comprising contacting said exhaust stream with the hydrocarbon trap catalytic article according to the present invention or the exhaust gas treatment system according to the present invention.

The present invention also provides a method of reducing hydrocarbons, carbon monoxide, and nitrogen oxide levels in a gaseous exhaust stream, the method comprising contacting a gaseous exhaust stream with the hydrocarbon trap catalytic article according to the present invention or the exhaust gas treatment system according to the present invention to reduce the levels of hydrocarbons, carbon monoxide, and nitrogen oxide in the exhaust gas.

In another aspect of the present invention, there is also provided use of the hydrocarbon trap catalytic article as a cold-start hydrocarbon trap. Preferably, the present invention provides use of the hydrocarbon trap catalytic article as a cold-start hydrocarbon trap in internal combustion engine.

It is found that exchanging silver (Ag) into zeolite such as beta zeolite can have a remarkable influence in HC release temperature. Fresh Ag-beta zeolite showed very high HC desorption temperature (~390° C. higher than fresh H-beta). However, after 850° C. aging its HC peak temperature became equivalent to an aged H-beta zeolite.

Fresh K-beta zeolite can moderately increase the HC desorption temperature relative to H-beta zeolite (by ~50° C.); after 850° C. aging, however, the advantage reduced to <20° C.

Interestingly, by loading both Ag and K in zeolite such as beta zeolite, the obtained material showed both high HC release temperature and excellent hydrothermal stability. On an aged Ag/K/Beta material, a HC release peak temperature that is >150° C. higher than the aged H-beta zeolite reference material is obtained.

When loaded with Ag and K, the composition of beta zeolite (SAR) becomes important in HC trapping/release performance. In a series of beta zeolite materials of different SARs, made from a template-free method, it is found that Ag/K/beta materials with SAR from 9.0 to 64 had excellent performance relative to the H-beta zeolite reference with HC peak temperatures at least 190° C. higher after aging.

Additionally, addition of other alkali metals, such as Na and Cs may also be effective in stabilizing Ag in zeolite. On the other hand, divalent metals, such as Mg, Ca and Zn, were found to be not effective in stabilizing Ag.

Further, it is found that for Ag/K/Beta compositions, the binder used for material preparation can make a difference in HC trap performance. A zirconia-based binder is superior to an alumina or silica-based binder as well as to a binder-free Ag/K/Beta compositions.

The invention is further described by the following embodiments. The features of each of the embodiments are combinable with any of the other embodiments where appropriate and practical.

### Embodiment 1

The present invention provides a hydrocarbon trap catalyst comprising a molecular sieve, the molecular sieve comprises a first metal and a second metal, wherein the first metal is potassium and the second metal is silver,

wherein the molecular sieve has a minimum pore diameter of at least 4.5 Å and a maximum pore diameter of less than 7.5 Å and a silica to alumina ratio (SAR) in the range of 9.0 to 90.0,

wherein the amount of potassium in the molecular sieve is in the range of 0.1% to 4.0% by weight, and the amount of silver in the molecular sieve is in the range of 0.2% to 10.0% by weight, in each case based on the total weight of the hydrocarbon trap catalyst.

### Embodiment 2

The hydrocarbon trap catalyst according to embodiment 1, wherein the molecular sieve comprises ion-exchanged potassium and silver.

### Embodiment 3

The hydrocarbon trap catalyst according to any of embodiments 1 to 2, wherein the molecular sieve has silica to alumina ratio (SAR) in the range of 20.0 to 64.0.

### Embodiment 4

The hydrocarbon trap catalyst according to any of embodiments 1 to 3, wherein the molecular sieve is zeolite.

### Embodiment 5

The hydrocarbon trap catalyst according to any of embodiments 1 to 4, wherein the molecular sieve is beta-zeolite.

### Embodiment 6

The hydrocarbon trap catalyst according to any of embodiments 1 to 5, wherein the molar ratio of potassium and silver in the molecular sieve is in the range of 1.5:1 to 1:1.5.

### Embodiment 7

The hydrocarbon trap catalyst according to any of embodiments 1 to 6, wherein the molar ratio of potassium to aluminum in the molecular sieve is in the range of 0.05 to 0.8.

### Embodiment 8

The hydrocarbon trap catalyst according to any of embodiments 1 to 7, wherein the molar ratio of silver to aluminum in the molecular sieve is in the range of 0.05 to 0.8.

### Embodiment 9

The hydrocarbon trap catalyst according to any of embodiments 1 to 8, wherein the catalyst further comprises a binder selected from zirconia, alumina, silica, or any combination thereof, wherein the amount of binder is in the range of 1.0 to 20.0% by weight, based on the total weight of the molecular sieve.

### Embodiment 10

The hydrocarbon trap catalyst according to any of embodiments 1 to 9, wherein the molecular sieve further comprises a dopant selected from lithium, sodium, cesium, calcium, magnesium, zinc, or any combination thereof, wherein the dopant is ion-exchanged and is present n an elemental form and wherein the amount of the dopant is in the range of 0.1 to 10% by weight, based on the total weight of the molecular sieve.

### Embodiment 11

The hydrocarbon trap catalyst according to any of embodiments 1 to 10, wherein the molecular sieve comprises: silver and potassium impregnated on the molecular sieve or liquid-phase ion exchanged silver and potassium on the molecular sieve; or solid-state ion exchanged silver and potassium on the molecular sieve.

### Embodiment 12

The hydrocarbon trap catalyst according to any of embodiments 1 to 11, wherein the BET surface area of the molecular sieve is 300 to 500 m²/g post aging at 850° C. for 5.0 hrs.

### Embodiment 13

A process for the preparation of the hydrocarbon trap catalyst as defined in any of embodiments 1 to 12, the said process comprises at least the following steps:
a. impregnating a silver salt solution on the molecular sieve to obtain a silver containing molecular sieve material;
b. calcining the silver containing molecular sieve material at a temperature ranging from 300 to 500° C. for 1.0 to 2.0 hours in air to obtain a calcined silver containing molecular sieve material;
c. impregnating a potassium salt solution on the calcined silver containing molecular sieve material to obtain a potassium-silver containing molecular sieve material; and
d. calcining the potassium-silver containing molecular sieve material at a temperature ranging from 500 to 600° C. for 1.0 to 2.0 hours to obtain the hydrocarbon trap catalyst.

### Embodiment 14

A hydrocarbon trap catalytic article comprising the hydrocarbon trap catalyst according to any of embodiments 1 to 12 deposited on a first substrate, wherein the first substrate is honeycomb substrate or flow through substrate.

### Embodiment 15

A hydrocarbon trap catalytic article comprises a first layer deposited at least on a part of the first substrate and a second layer deposited at least on a part of the first layer, wherein the first layer comprises the hydrocarbon trap catalyst as defined in any of embodiments 1 to 12; and the second layer comprises a three-way conversion catalyst comprising at least one platinum group metal selected from platinum, palladium or rhodium supported on a support.

### Embodiment 16

A hydrocarbon trap catalytic article comprises a first zone and a second zone, wherein the first zone comprises the hydrocarbon trap catalyst as defined in any of embodiments 1 to 12 deposited at least on a part of the first substrate and the second zone comprising a three-way conversion catalyst comprising at least one platinum group metal selected from platinum, palladium or rhodium supported on a support, deposited at least on a part of the first substrate.

### Embodiment 17

The present invention provides an exhaust gas treatment system comprising the hydrocarbon trap catalytic article according to any of embodiments 14 to 16; and optionally, a three-way conversion catalytic article.

### Embodiment 18

The exhaust gas treatment system according to embodiment 1, wherein the system comprises an engine producing an exhaust gas stream; the hydrocarbon trap catalytic article according to any of embodiments 14 to 16; and a three-way conversion catalytic article,

wherein the hydrocarbon trap catalytic article is positioned downstream from the engine and the three-way conversion catalytic article is positioned downstream in fluid communication with the hydrocarbon trap catalytic article.

### Embodiment 19

Use of the hydrocarbon trap catalytic article according to any of embodiments 14 to 16, as a cold-start hydrocarbon trap.

Aspects of the presently claimed invention are more fully illustrated by the following examples, which are set forth to illustrate certain aspects of the present invention and are not to be construed as limiting thereof.

### Example 1: Preparation of Different Zeolites (with or without a Metal)

### Samples 1 to 6

Sample 1 is a H-beta zeolite obtained by calcining a commercial NH4-beta zeolite at 550° C. for 2 hours in an oven.

Samples 2 to 6 were prepared by ion exchanging a metal cation with the NH4-beta zeolite (precursor of Sample 1) in a liquid phase. Metal nitrate salts were used for Samples 1, 5 and 6, and metal acetate salts were used for Samples 3 and 4. Specifically, a 20-g (dry basis) portion of the parent zeolite (NH4-beta) was weighed and set aside. A calculated amount of metal salt was dissolved in 800 mL deionized water that contained in a 2-L beaker to make 0.1 M metal solution. The parent zeolite was added to the metal solution with constant stirring. For Ag exchange, the beaker was completely covered with aluminum foil because Ag is light-sensitive. For all other exchanges, aluminum foil covers only the top of the beaker to minimize evaporation of water. Heat was applied to the slurry using a hot plate to reach a solution temperature of 70-80° C., and it was held at this temperature for 24 h. After the exchange, heat was turned off to allow the slurry to cool to near room temperature. The slurry was filtered using a vacuum filter, and the filter cake was washed using a 1-L deionized water with constant stirring at room temperature for 2 h and then filter again. The filter cake was then dried at 110° C. for 2 h and calcined at 500° C. for 2 h in an oven. The calcined material was analyzed by XRF to obtained SiO2/Al2O3 molar ratio (SAR) and metal loading, which are shown in Table

TABLE 1
Details of zeolite samples 1 to 6

| Sample | Sample | SiO2/Al2O3 molar | Metal loading | Me/Al |
|---|---|---|---|---|
| No. | name | ratio (SAR) | (wt. %) | molar ratio |
| 1 | H-Beta | 25 | — | — |
| 2 | Ag-Beta | 21 | 6.06 | 0.40 |
| 3 | Ni-Beta | 22 | 5.49 | 0.71 |
| 4 | Co-Beta | 22 | 4.64 | 0.61 |
| 5 | K-Beta | 22 | 2.51 | 0.46 |
| 6 | Pd-Beta | 92 | 0.44 | 0.12 |

### Example 2: Zeolite Containing Potassium or Silver or Both

### Samples 7 to 12

Sample 7 is a H-beta zeolite with a SAR >100, which was obtained from a commercial source. Sample 8 is an Ag-Beta obtained using a procedure similar to Sample 2. Specifically, a 20-g (dry basis) portion of the parent zeolite (NH4-beta) was weighed and set aside. A calculated amount of metal salt was dissolved in 800 mL deionized water that contained in a 2-L beaker to make 0.05 M metal solution. The parent zeolite (NH4-beta) was added to the metal solution with constant stirring. The beaker was completely covered with aluminum foil during the exchange. Heat was applied to the slurry using a hot plate to reach a solution temperature of 70-80° C., and it was held at this temperature for 24 h. After the exchange, heat was turned off to allow the slurry to cool to near room temperature. The slurry was filtered using a vacuum filter, and the filter cake was washed using a 1-L deionized water with constant stirring at room temperature for 2 h and then filter again. The filter cake was then dried at 110° C. for 2 h and calcined at 500° C. for 2 h in an oven. The XRF analysis of the calcined material shows that the material contains 3.76 wt. % Ag. Sample 9 is an Ag-Beta obtained using a procedure similar to Sample 2. Specifically, a 20-g (dry basis) portion of the parent zeolite (NH4-beta) was weighed and set aside. A calculated amount of metal salt was dissolved in 200 mL deionized water that contained in a 2-L beaker to make 0.1 M metal solution. The parent zeolite (NH4-beta) was added to the metal solution with constant stirring. The beaker was completely covered with aluminum foil during the exchange. Heat was applied to the slurry using a hot plate to reach a solution temperature of 70-80° C., and it was held at this temperature for 24 h. After the exchange, heat was turned off to allow the slurry to cool to near room temperature. The slurry was filtered using a vacuum filter, and the filter cake was washed using a 1-L deionized water with constant stirring at room temperature for 2 h and then filter again. The filter cake was then dried at 110° C. for 2 h and calcined at 500° C. for 2 h in an oven. The XRF analysis of the calcined material shows that the material contains 2.7 wt. % Ag. Sample 10 was prepared by impregnating Ag nitrate solution on H-Beta (Sample 1) using the incipient wetness technique. The impregnated sample was calcined at 500° C. for 1 h. The calcined sample was calculated to contain 3.7 wt. % Ag.

Sample 11 was prepared by impregnating K nitrate solution on H-Beta (Sample 1) using the incipient wetness technique. The impregnated sample was calcined at 500° C. for 1 h. The calcined sample was calculated to contain 1.1 wt. % K.

Sample 12 was prepared by impregnating K nitrate solution on 3.76Ag-Beta (Sample 8) using the incipient wetness technique. The impregnated sample was calcined at 500° C. for 1 h. The calcined sample was calculated to contain 3.76 wt. % Ag and 1.1 wt. % K.

TABLE 2
Details of zeolite samples 7 to 12

| Sample | | | Ag loading | K loading |
|---|---|---|---|---|
| No. | Sample name | SAR | (wt. %) | (wt. %) |
| 1 | H-Beta | 25 | — | — |
| 7 | H-(Si) Beta | >100 | — | — |
| 8 | 3.76Ag-Beta | 25 | 3.76 | — |
| 9 | 2.7Ag-Beta | 25 | 2.7 | — |
| 10 | 3.7Ag/Beta | 25 | 3.7 | — |
| 11 | 1.1K/Beta | 25 | — | 1.1 |
| 12 | 1.1K/3.76Ag-Beta | 25 | 3.76 | 1.1 |

### Example 3: Zeolite with Varying SAR

### Samples 13 to 22

Sample 13 is a H-Beta zeolite with a SAR of 21. The H-Beta (SAR=21) was suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 14 is a H-Beta zeolite with a SAR of 64. The H-Beta (SAR=64) was suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 15 is a H-Beta zeolite with a SAR of 100. The H-Beta (SAR=100) was suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 16 was prepared by sequentially impregnating Ag and K on a H-Beta zeolite (Sample 1). Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 17 was prepared by sequentially impregnating Ag and K on a H-Beta zeolite with SAR=42. Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 18 was prepared by sequentially impregnating Ag and K on a H-Beta zeolite with SAR=9. Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 19 was prepared by sequentially impregnating Ag and K on a H-Beta zeolite with SAR=16. Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 20 was prepared by sequentially impregnating Ag and K on a H-Beta zeolite with SAR=21. Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 21 was prepared by sequentially impregnating Ag and K on a H-Beta zeolite with SAR=64. Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 22 was prepared by sequentially impregnating Ag and K on a H-Beta zeolite with SAR=100. Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

TABLE 3
Details of zeolite samples 13 to 22

| Sample | | | Ag loading | K loading |
|---|---|---|---|---|
| No. | Sample name | SAR | (wt. %) | (wt. %) |
| 1 | H-Beta | 25 | — | — |
| 13 | H-Beta(SAR21) | 21 | — | — |
| 14 | H-Beta(SAR64) | 64 | — | — |
| 15 | H-Beta(SAR100) | 100 | — | — |
| 16 | 1.0K/2.76Ag/Beta(SAR25) | 25 | 2.76 | 1.0 |
| 17 | 1.0K/2.76Ag/Beta(SAR42) | 42 | 2.76 | 1.0 |
| 18 | 1.0K/2.76Ag/Beta(SAR9) | 9 | 2.76 | 1.0 |
| 19 | 1.0K/2.76Ag/Beta(SAR16) | 16 | 2.76 | 1.0 |
| 20 | 1.0K/2.76Ag/Beta(SAR21) | 21 | 2.76 | 1.0 |
| 21 | 1.0K/2.76Ag/Beta(SAR64) | 64 | 2.76 | 1.0 |
| 22 | 1.0K/2.76Ag/Beta(SAR100) | 100 | 2.76 | 1.0 |

### Example 4: Zeolite with Binder

### Samples 23 to 30

Sample 23 was prepared by sequentially impregnating Ag and K on a H-Beta zeolite (Sample 1). Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 24 was prepared by sequentially impregnating Ag and K on a H-Beta zeolite (Sample 1). Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. An alumina-based binder (boehmite), equivalent to 5 wt. % zeolite support as Al2O3, was added to the slurry with stirring and then milled for 5 min. The milled slurry was dried under stirring and calcined at 550° C. for 1 h in air.

Sample 25 was prepared by sequentially impregnating Ag and K on a H-Beta zeolite (Sample 1). Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. A colloidal silica binder, equivalent to 5 wt. % zeolite support as SiO2, was added to the slurry with stirring and then milled for 5 min. The milled slurry was dried under stirring and calcined at 550° C. for 1 h in air.

Sample 26 was prepared by sequentially impregnating Ag and K on a H-Beta zeolite (Sample 1). Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The obtained material contains 2.76 wt. % Ag and 1.00 wt. % K. The calcined K/Ag/Beta material was then suspended in de-ionized water to make a slurry of about 30 wt. % solid. The slurry was milled for 5 min. [No binder was added to this slurry.] The milled slurry was dried under stirring and calcined at 550° C. for 1 h in air.

Sample 27 was prepared by sequentially impregnating Ag and Mg on a H-Beta zeolite (Sample 1). Ag nitrate solution was first impregnated on Sample 1 using the incipient wetness technique and calcined at 400° C. for 1 h in air. Mg nitrate solution was then impregnated on the calcined Ag/Beta and then calcined at 550° C. for 1 h in air. The obtained material contains 2.76 wt. % Ag and 0.32 wt. % Mg. The calcined Mg/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 28 was prepared by sequentially impregnating Ag and Ca on a H-Beta zeolite (Sample 1). Ag nitrate solution was first impregnated on Sample 1 using the incipient wetness technique and calcined at 400° C. for 1 h in air. Ca nitrate solution was then impregnated on the calcined Ag/Beta and then calcined at 550° C. for 1 h in air. The obtained material contains 2.76 wt. % Ag and 0.54 wt. % Ca. The calcined Ca/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 29 was prepared by sequentially impregnating Ag and Zn on a H-Beta zeolite (Sample 1). Ag nitrate solution was first impregnated on Sample 1 using the incipient wetness technique and calcined at 400° C. for 1 h in air. Zn nitrate solution was then impregnated on the calcined Ag/Beta and then calcined at 550° C. for 1 h in air. The obtained material contains 2.76 wt. % Ag and 0.85 wt. % Zn. The calcined Zn/Ag/Beta material was then suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

Sample 30 is a K/Ag/Al2O3 reference material. It was prepared by sequentially impregnating Ag and K on a gamma-Al2O3 support. Ag nitrate solution was first impregnated on the Al2O3 support using the incipient wetness technique and calcined at 400° C. for 1 h in air. K nitrate solution was then impregnated on the calcined Ag/Al2O3 and then calcined at 550° C. for 1 h in air. The obtained material contains 2.76 wt. % Ag and 1.00 wt. % K. The calcined K/Ag/Al2O3 material was then suspended in de-ionized water to form a slurry of about 30 wt. % solid. An alumina-based binder (boehmite), equivalent to 5 wt. % of the support as Al2O3, was added to the slurry with stirring and then milled for 5 min. The milled slurry was dried under stirring and calcined at 550° C. for 1 h in air.

TABLE 4
Details of zeolite samples 23 to 30

| Sample | | Ag loading | Co-dopant | |
|---|---|---|---|---|
| No. | Sample name | (wt. %) | (wt. %) | Binder |
| 23 | K/Ag/Beta_Zr | 2.76 | 1.00 K | 5% ZrO2 from Zr acetate |
| 24 | K/Ag/Beta_Al | 2.76 | 1.00 K | 5% Al2O3 from boehmite |
| 25 | K/Ag/Beta_Si | 2.76 | 1.00 K | 5% SiO2 from colloidal SiO2 |
| 26 | K/Ag/Beta_milled | 2.76 | 1.00 K | No binder/milled |
| 27 | Mg/Ag/Beta_Zr | 2.76 | 0.32Mg | 5% ZrO2 from Zr acetate |
| 28 | Ca/Ag/Beta_Zr | 2.76 | 0.54 Ca | 5% ZrO2 from Zr acetate |
| 29 | Zn/Ag/Beta_Zr | 2.76 | 0.85 Zn | 5% ZrO2 from Zr acetate |
| 30 | K/Al2O3_Al | 2.76 | 1.00 K | 5% Al2O3 from boehmite |

### Example 5: K/Ag/Zeolite HC Trap as a Function of K and Ag Loading

### Sample 31 to Sample 37

Sample 31 to Sample 37 were prepared by sequentially impregnating Ag and K on a H-Beta zeolite (Sample 1). Ag nitrate solution was first impregnated on Sample 1 using the incipient wetness technique and calcined at 400° C. for 1 h in air. K nitrate solution was then impregnated on the calcined Ag/Beta and then calcined at 550° C. for 1 h in air. The compositions of the obtained materials are tabulated in Table 5. Each of the calcined K/Ag/Beta material was suspended in de-ionized water to make a slurry of about 30 wt. % solid. A zirconium acetate binder, equivalent to 5 wt. % zeolite support as ZrO2, was added to the slurry with stirring and then milled for 5 min. The milled slurry was dried under stirring and calcined at 550° C. for 1 h in air.

TABLE 5
Details of zeolite samples 31 to 37

| Sample | | Ag loading | K loading | |
|---|---|---|---|---|
| No. | Sample name | (wt. %) | (wt. %) | Binder/shaping |
| 31 | 0.5K/1.38Ag/Beta | 1.38 | 0.5 | 5% ZrO2 from Zr acetate |
| 32 | 0.75/1.38/Beta | 1.38 | 0.75 | 5% ZrO2 from Zr acetate |
| 33 | 1.0K/1.38Ag/Beta | 1.38 | 1.0 | 5% ZrO2 from Zr acetate |
| 34 | 0.5K/2.76Ag/Beta | 2.76 | 0.5 | 5% ZrO2 from Zr acetate |
| 35 | 1.0K/2.76Ag/Beta | 2.76 | 1.0 | 5% ZrO2 from Zr acetate |
| 36 | 2.0K/2.76Ag/Beta | 2.76 | 2.0 | 5% ZrO2 from Zr acetate |
| 37 | 2.0K/4.16Ag/Beta | 4.14 | 2.0 | 5% ZrO2 from Zr acetate |

### Example 6 Ag/Beta Zeolite Modified with Li, Na or Cs

Sample 38 to Sample 40 were prepared by sequentially impregnating Ag and alkali metal (Li, Na or Cs) on a H-Beta zeolite (Sample 1). Ag nitrate solution was first impregnated on Sample 1 using the incipient wetness technique and calcined at 400° C. for 1 h in air. For the second impregnation, the nitrate solution of Li (Sample 38), Na (Sample 39) or Cs (Sample 40) was used as the alkali metal precursor. After the second impregnation, all samples were calcined at 550° C. for 1 h in air. The compositions of the obtained materials are tabulated in Table 6. Each of the calcined materials was suspended in de-ionized water to make a slurry of about 30 wt % solid. A zirconium acetate binder, equivalent to 5 wt % zeolite support as ZrO2, was added to the slurry with stirring and then milled for 5 min. The milled slurry was dried under stirring and calcined at 550° C. for 1 h in air.

TABLE 6
Details of zeolite samples 35 to 40

| Sample | | Ag loading | Co-dopant | |
|---|---|---|---|---|
| No. | Sample name | (wt. %) | (wt. %) | Binder/shaping |
| 35 | 1.0K/2.76Ag/Beta | 2.76 | 1.0 K | 5% ZrO2 from Zr acetate |
| 38 | 0.18Li/2.76Ag/Beta | 2.76 | 0.18 Li | 5% ZrO2 as Zr acetate |
| 39 | 0.59Na/2.76Ag/Beta | 2.76 | 0.59 Na | 5% ZrO2 as Zr acetate |
| 40 | 3.39Cs/2.76Ag/Beta | 2.76 | 3.39 Cs | 5% ZrO2 as Zr acetate |

### Example 7: Testing

### Sample Shaping and Aging Procedures:

All samples were crushed and sieved to 250-500 μm fracture before performance test.

All samples were aged at 850° C. for 5 h with 10% steam with a lean/rich feed (10 min 4% O2/N2/10 min. H2/N2). Selected samples were also aged at 750° C. for 5 h with the same feed condition.

### HC Trap Test

HC trap was measured with a feed containing 200 ppm C1 toluene, 0.5% CO, 0.2% H2, 200 ppm NO, ~0.4% 02, 10% H2O, balance N2 (actual O2 was adjusted to λ=1). The gas hourly space velocity is equivalent to 40,000 h⁻¹ when normalized to 3 mL coated catalyst. A catalyst was first set at 50° C. and exposed to 10% H2O/air for 5 min. The full feed was equilibrated for 15 min in a bypass mode. The full feed was then switched to the sample to be measured at 50° C. and held at this temperature for 90 s. Following the soaking period, the sample was heated to 550° C. at a ramp rate of 40° C./min while flowing the feed through the sample. Hydrocarbon (HC) concentration was continuously monitored throughout the experiment using a flame ionization detector. HC concentration below 200 ppm (inlet level) is considered as HC adsorption, while above 200 ppm as HC release or desorption. The HC concentration profile is plotted as a function temperature to identify the HC release (desorption) temperature. The amount of HC adsorbed can be integrated against time from time=0 to the point where HC concentration reached to 200 ppm. The among of HC released is obtained by integrating the HC concentration above 200 ppm.

### Findings:

H-beta zeolites showed too low hydrocarbon desorption temperatures, especially after hydrothermal aging. Similar performance was observed on all beta zeolites of different SAR.
Several transition metals (Cu, Ni, Co, Pd, K and Ag) were exchanged into a beta zeolite. Cu, Ni, Co, Pd exchanged beta samples did not show significant differences in HC desorption temperature relative to a H-beta zeolite.
Fresh K-beta increased the HC desorption temperature relative to H-beta (by ~50° C.); after 850° C. aging, however, the advantage reduced to <20° C.
Fresh Ag-beta showed very high HC desorption temperature (~390° C. higher than fresh H-beta). However, after 850° C. aging its HC peak temperature became equivalent to an aged H-beta zeolite.
Ag/K loaded zeolites showed surprisingly high HC release temperatures and excellent hydrothermal stability.
Fresh Ag/K/beta maintained the HC peak temperature of that of Ag/beta.
850° C. aged Ag/K/beta continued to show high HC peak temperature (~180° C. higher than aged H-beta). Thus, Ag/K/beta largely maintained the fresh Ag/K/beta performance and is much more thermally stable than all single-cation/beta.
For Ag/K/beta, the characteristics of HC release are related to zeolite composition. Among them, Ag/K/beta (SAR 9), Ag/K/beta (SAR 16) and Ag/K/beta (SAR 64) showed overall best performance.
Binder used for sample preparation has an impact on the performance of Ag/K/beta. Zr binder is superior to Al or Si binder as well as to the binder-free Ag/K/beta sample.
Other cations (Mg, Ca, Zn) in place of K on an equivalent molar basis in Ag/beta showed inferior performance relative to Ag/K/beta after aging.
Li or Na in place of K on an equivalent molar basis in Ag/beta showed inferior performance relative to Ag/K/beta after aging.
Cs in place of K on an equivalent molar basis in Ag/beta showed comparable performance to Ag/K/beta after aging.

1. A hydrocarbon trap catalyst comprising a molecular sieve, the molecular sieve comprises a first metal and a second metal,
wherein the first metal is potassium and the second metal is silver,
wherein the molecular sieve has a minimum pore diameter of at least 4.5 A and a maximum pore diameter of less than 7.5 A and a silica to alumina ratio (SAR) in the range of 9.0 to 90.0,
wherein the amount of potassium in the molecular sieve is in the range of 0.1% to 4.0% by weight, and the amount of silver in the molecular sieve is in the range of 0.2% to 10.0% by weight, in each case based on the total weight of the hydrocarbon trap catalyst.

2. The hydrocarbon trap catalyst according to claim 1, wherein the molecular sieve comprises ion-exchanged potassium and silver.

3. The hydrocarbon trap catalyst according to claim 1, wherein the molecular sieve has silica to alumina ratio (SAR) in the range of 20 to 64.

4. The hydrocarbon trap catalyst according to claim 1, wherein the molecular sieve is zeolite.

5. The hydrocarbon trap catalyst according to claim 1, wherein the molecular sieve is beta-zeolite.

6. The hydrocarbon trap catalyst according to claim 1, wherein the molar ratio of potassium and silver in the molecular sieve is in the range of 1.5:1 to 1:1.5.

7. The hydrocarbon trap catalyst according to claim 1, wherein the molar ratio of potassium to aluminum in the molecular sieve is in the range of 0.05 to 0.8.

8. The hydrocarbon trap catalyst according to claim 1, wherein the molar ratio of silver to aluminum in the molecular sieve is in the range of 0.05 to 0.8.

9. The hydrocarbon trap catalyst according to claim 1, wherein the catalyst comprises a binder selected from zirconia, alumina, silica, or any combination thereof, wherein the amount of binder is in the range of 1.0 to 20.0% by weight, based on the total weight of the molecular sieve.

10. The hydrocarbon trap catalyst according to claim 1, wherein the molecular sieve comprises a dopant selected from lithium, sodium, caesium, calcium, magnesium, zinc, or any combination thereof, wherein the dopant is ion-exchanged and is present in an elemental form and wherein the amount of the dopant is in the range of 0.1 to 10.0% by weight, based on the total weight of the molecular sieve.

11. The hydrocarbon trap catalyst according to claim 1, wherein the molecular sieve comprises: silver and potassium impregnated on the molecular sieve or liquid-phase ion exchanged silver and potassium on the molecular sieve; or solid-state ion exchanged silver and potassium on the molecular sieve.

12. The hydrocarbon trap catalyst according to claim 1, wherein the BET surface area of the molecular sieve is 300 to 500 m²/g post aging at 850° C. for 5.0 hrs.

13. A process for the preparation of the hydrocarbon trap catalyst as defined in claim 1, the said process comprises at least the following steps:
a) impregnating a silver salt solution on the molecular sieve to obtain a silver containing molecular sieve material;
b) calcining the silver containing molecular sieve material at a temperature ranging from 300 to 500° C. for 1.0 to 2.0 hours in air to obtain a calcined silver containing molecular sieve material;
c) impregnating a potassium salt solution on the calcined silver containing molecular sieve material to obtain a potassium-silver containing molecular sieve material; and
d) calcining the potassium-silver containing molecular sieve material at a temperature ranging from 500 to 600° C. for 1.0 to 2.0 hours to obtain the hydrocarbon trap catalyst.

14. A hydrocarbon trap catalytic article comprising the hydrocarbon trap catalyst as defined in claim 1 deposited on a first substrate, wherein the first substrate is honeycomb substrate or flow through substrate.

15. The hydrocarbon trap catalytic article comprising a first layer deposited at least on a part of the first substrate and a second layer deposited on at least a part of the first layer, wherein the first layer comprises the hydrocarbon trap catalyst as defined in claim 1; and the second layer comprises a three-way conversion catalyst comprising at least one platinum group metal selected from platinum, palladium or rhodium supported on a support.

16. The hydrocarbon trap catalytic article comprising a first zone and a second zone, wherein the first zone comprises the hydrocarbon trap catalyst as defined in claim 1 deposited at least on a part of the first substrate and the second zone comprising a three-way conversion catalyst comprising at least one platinum group metal selected from platinum, palladium or rhodium supported on a support, deposited at least on a part of the first substrate.

17. An exhaust gas treatment system comprising:
a) the hydrocarbon trap catalytic article according to claim 14; and
b) optionally, a three-way conversion catalytic article.

18. The exhaust gas treatment system according to claim 17, wherein the system comprises:
i. an engine producing an exhaust gas stream;
ii. the hydrocarbon trap catalytic article wherein the first substrate is honeycomb substrate or flow through substrate; and
iii. a three-way conversion catalytic article,
wherein the hydrocarbon trap catalytic article is positioned downstream from the engine and the three-way conversion catalytic article is positioned downstream in fluid communication with the hydrocarbon trap catalytic article.

19. Use of the hydrocarbon trap catalytic article according to claim 14, as a cold-start hydrocarbon trap.
